(19) United States
(12) Patent Application Publication
(10) Pub. No.: US 2003/0188910 A1
(43) Pub. Date: Oct. 9, 2003

(54) Skid steer vehicle with axle housings directly driven by a hydraulic motor

(75) Inventors: Troy D. Bateman, Joliet, IL (US); Anthony J Lamela, Gilberts, IL (US)

Correspondence Address: INTELLECTUAL PROPERTY LAW DEPARTMENT CASE LLC, 700 STATE STREET, RACINE, WI, 53404, US

(73) Assignee: CASE CORPORATION

(21) Appl. No.: 10/116,883

(22) Filed: Apr. 5, 2002

(51) Int. Cl. B60K 17/00

(52) U.S. Cl. 180/305

(57) ABSTRACT

A skid steer vehicle has a drive system that includes hydraulic motor coupled to a speed-reduction gearbox. One or more drive shafts extend fore-and-aft from the gearbox and are coupled at each end to two axle housings. Each axle housing includes two reduction gear sets and an axle. Each of the axles extends outward from the vehicle and a wheel is fixed to its outer end. A spur gear on a parallel shaft inside the axle housing engages a spur gear on the axle and drives it to provide one gear reduction. A bevel gear in the axle housing engages a bevel gear on the parallel shaft to provide another gear reduction. The vehicle has a drive system located on each side of the vehicle to collectively drive four wheels.

### FIELD OF THE INVENTION

The invention relates generally to drive systems for skid steer vehicles. More particularly, it relates to skid steer vehicles having axle housings that are coupled to a hydraulic motor to drive the vehicle over the ground.

### BACKGROUND OF THE INVENTION

Skid steer vehicles such as skid steer loaders were invented perhaps thirty years ago to provide a small vehicle on a highly maneuverable platform for working in close quarters on construction sites. They were called “skid steer loaders” since they had fixed axles, two per side, and could drive the wheels on one side of a vehicle at one speed and the wheels on the other side of the vehicle at a second speed. To turn the vehicles, the wheels on each side of the vehicle are driven at different speed, and even in opposite directions. It is this latter mode of operation that permits the vehicles to rotate about a vertical axis.

The drive mechanisms for these vehicles rely upon the fact that, on each side of the vehicle, the wheels were driven at the same speed. Each wheel is supported by an axle and the axles on the same side of the vehicle are driven by a single motor. The axles on the other side of the vehicle are driven by a second motor.

As these vehicles have developed, the axles were quite long and extended from the outside of the vehicle through a sidewall of the vehicle and into the interior of the vehicle, where they are joined via chains to a common hydraulic motor. Since chains are subject to wear, however, they need frequent replacement at some expense. Since they are located within the sidewalls of the vehicle, the chain tank takes up space that could be better used as space for the operator. The use of chains requires a longitudinally extending chain tank or chain bucket in which oil baths the chain. Since this tank extends from forward axle to rearward axle, it extends substantially the entire length of the vehicle.

By extending all the axles into the center of the vehicle and driving them from a common central chain tank, the drive mechanism consumes considerable interior space. Furthermore, by using chains to connect the motors to the axles, the vehicles require regular chain replacement, which increases down time.

What is needed, therefore, is a skid steer vehicle with a drive system that does not require a chain tank or periodic replacement of a drive chain. What is also needed is a skid steer vehicle in which the drive components have been moved to the sides of the vehicle, thereby permitting a larger internal open space.

It is an object of this invention to provide such a system in one or more claimed embodiments.

### SUMMARY OF THE INVENTION

In accordance with a first embodiment of the invention, a skid steer vehicle is provided that has a direct drive system eliminating the extended drive chain of the traditional skid steer vehicle and replacing it with a gear drive that couples a hydraulic motor to a forward and aft drive wheel. This arrangement is provided on both sides of the vehicle. It disposes the drive elements adjacent to the sidewalls of the vehicle thereby reducing the intrusion of drive components near the center of the vehicle and directly couples the hydraulic motor to axle housings.

This system includes a hydraulic motor that is centrally located between front and rear axle housings. This motor is coupled to both the front and the rear axle housings to provide power to both of them. The forward and rear axle housing each contain three sets of reduction gears to reduce speed and increase torque.

The vehicle has two such drive systems, one disposed on either side of the vehicle, and each driving two wheels arranged in a fore-and-aft orientation. Each wheel is fixed to an axle extending from and supported by a corresponding one of the axle housings.

### BRIEF DESCRIPTION OF THE DRAWINGS

The present invention will become more fully understood from the following detailed description, taken in conjunction with the accompanying drawings, wherein like reference numerals refer to like parts, in which:

FIG. 1 is a side view of a skid steer vehicle (here shown as a skid steer loader) in accordance with the present invention;

FIG. 2 is a top view of the vehicle of the preceding FIGURE taken at section line 2-2 in FIG. 1 showing the drive systems;

FIG. 3 is a partial cutaway view of the vehicle showing the left hand drive system in more detail, including its internal components and gears;

FIG. 4 is a cross-sectional view the forward axle housing of the left side drive system showing the internal components including the axle and the three speed-reducing gear sets;

FIG. 5 is a cross-sectional view the rear axle housing of the left side drive system showing the internal components including the axle and the three speed reducing gear sets;

FIGS. 6 and 7 are partial cutaway top views of the left hand drive system showing the hydraulic motor as installed (FIG. 6), and partially installed (FIG. 7) to indicate how the motor may be inserted and removed from the drive system;

FIG. 8 is a schematic diagram of the left hand drive system showing the relationship of gears in schematic form; and

FIG. 9 is a schematic diagram of the hydraulic drive circuit for driving the hydraulic motors indicating how pumps are coupled to drive motors on both sides of the vehicle to supply them with hydraulic fluid and thereby drive the vehicle over the ground.

### DETAILED DESCRIPTION OF THE PREFERRED EMBODIMENT

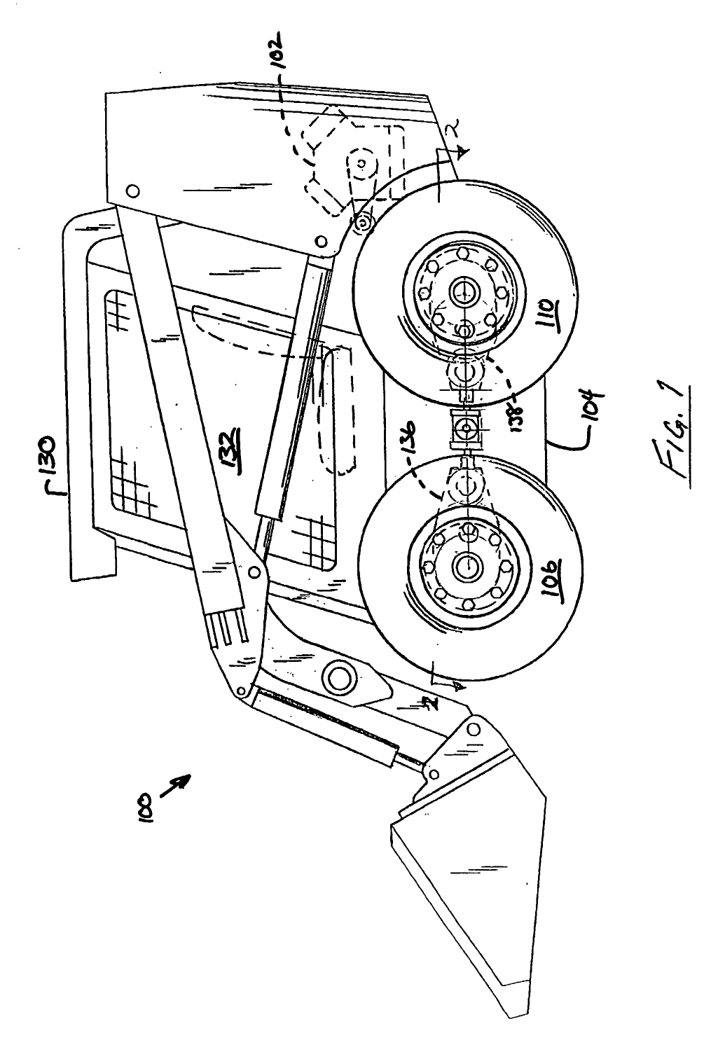

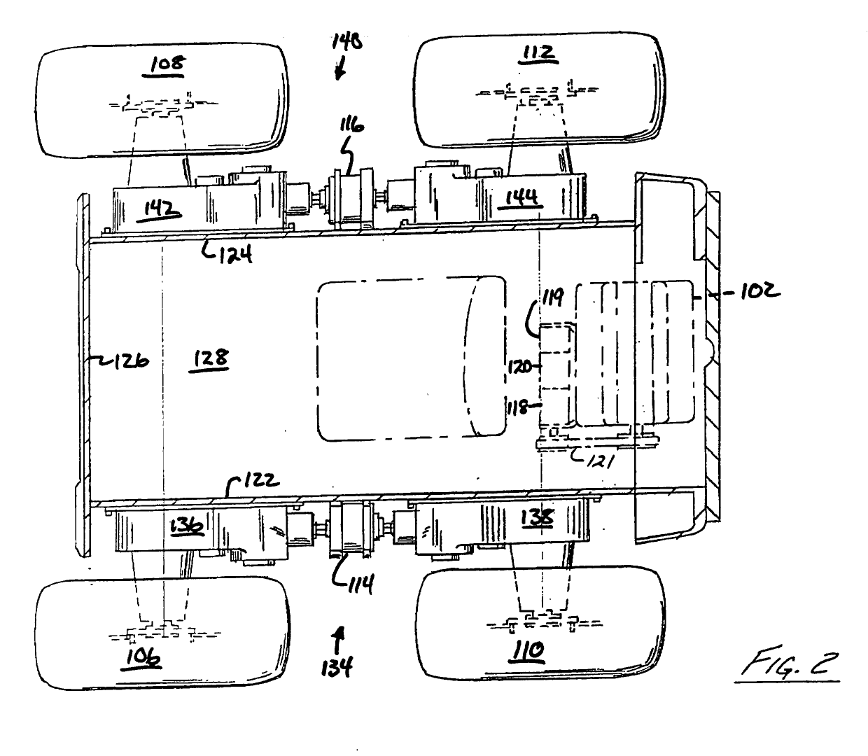

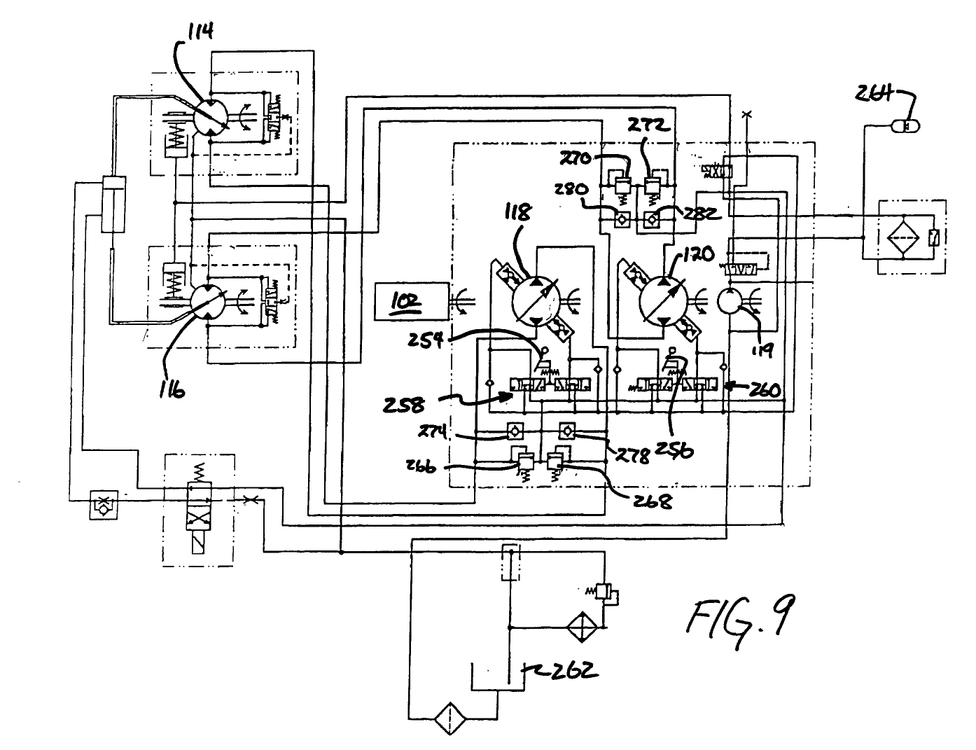

FIGS. 1 and 2 show a skid steer vehicle 100 having an engine 102 that is mounted on a chassis 104. The chassis 104 is supported on two front wheels 106, 108 and two rear wheels 110 and 112. Hydraulic motors 114 and 116 respectively drive two pairs of wheels 106, 110 and 108, 112. Hydraulic fluid for hydraulic motors 114 and 116 is provided by hydraulic pumps 118, 120, to which motors 114 and 116 are respectively fluidly coupled. Pumps 118 and 120 are coupled to and driven by engine 102. A charge pump 119 is also coupled to and driven by engine 102 to provide hydraulic fluid to the circuits coupling the motors and the other pumps. The hydraulic circuit can be seen in greater detail in FIG. 9.

Engine 102 is preferably an internal combustion engine such as a 2 to 6 cylinder gasoline or diesel engine. Hydraulic pumps 118 and 120 are driven by the crankshaft of engine 102, to which they are rotationally coupled by belt 121.

Chassis 104 includes two sidewalls 122 and 124 disposed on the left and the right side of the vehicle, respectively, as well as forward wall 126 and floor pan 128. The walls and the floor pan, together with engine 102 and rollover cage 130 (which is coupled to the chassis) define the general outlines of the operator's compartment 132.

Each side of the vehicle is equipped with a drive system that drives the vehicle over the ground. The drive system 134 for the left side of the vehicle includes hydraulic motor 114, front and rear axle housings 136 and 138, and drive wheels 106 and 110. The drive system 140 for the right side of the vehicle includes hydraulic motor 116, front and rear axle housings 142, and 144, and drive wheels 108 and 112. Drive systems 134 and 140 are mirror images of each other mirrored about a longitudinal centerline of the vehicle.

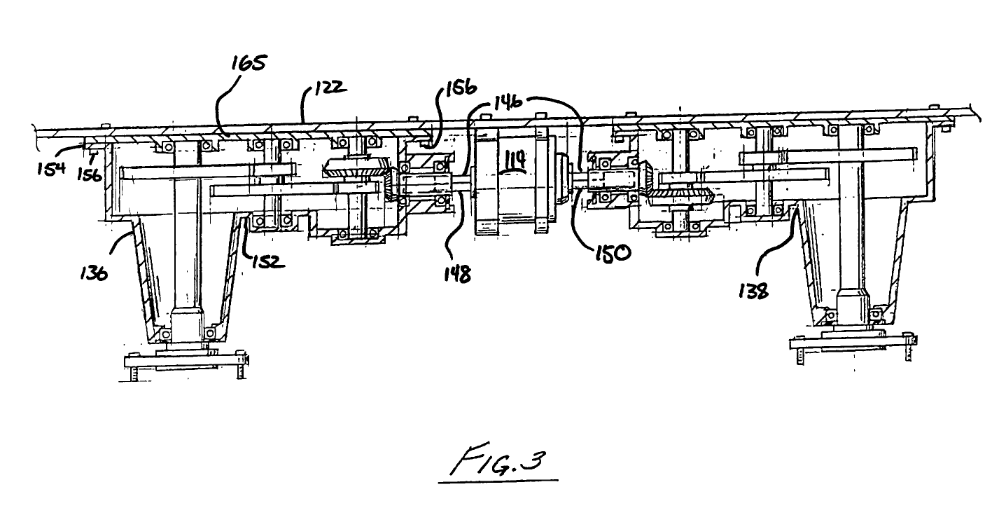

Regarding drive system 134, and as best shown in FIGS. 3-5, hydraulic motor 114 is coupled to front and rear axle housings 136 and 138 to drive them. Shaft 146 of hydraulic motor 114 extends fore-and-aft with respect to the vehicle and rotates whenever hydraulic fluid from hydraulic pump 118 is directed through it. Shaft 146 has two ends: a forwardly extending end 148 and a rearwardly extending end 150. These ends are rotationally coupled to bevel pinion gears in the front and rear axle housings, respectively, and drive them in rotation at the same speed. The forward end 148 terminates in front axle housing 136 and the rearward end of the driveshaft terminates in rear axle housing 138. Both ends of the shaft 146 inherently rotate in the same direction and at the same speed.

Front axle housing 136 includes an elongated generally conical casing 152 that has a smaller conical diameter the farther one moves away from the vehicle toward wheel 106. This casing 152 includes a flange 154 at its inboard edge through which a plurality of bolts 156 are inserted to fix the flange (and hence casing 152) to left sidewall 122 of the vehicle.

Casing 152, like the three other casings of the vehicle, supports the weight of the vehicle as it travels over the ground. The weight of the vehicle is transmitted from the chassis to the flanges, and thence through axle bearings located in the casing to the axle. The weight on the axle is thence transmitted to the ground.

Axle housing 136 includes a cover 165 that is bolted to and encloses casing 152. Three bearings 160, 162, and 164 are fixed to and supported by cover 165. These bearings respectively support axle 166, gear shaft 168, and gear shaft 170 at their inner ends for rotation with respect to axle housing 136. Bolts 172 extend through holes in cover 165 into casing 152 to which they are threadedly engaged to fix cover 165 thereto.

Axle housing 136 has three speed-reducing gear sets 174, 176, and 178 that are connected in series to reduce the speed of motor 114 and increase the torque applied to the wheels.

Gear set 174 includes two bevel gears, a bevel pinion gear 180 and a bevel gear 182 disposed at right angles to gear 180. The two gears are in meshing engagement with gear 180 driving gear 182. It is speed-reducing since gear 180 has fewer teeth than gear 182.

Bevel pinion gear 180 includes an elongated cylindrical portion that is supported within an aperture in casing 152. Bearings 184 and 186 are mounted on the cylindrical portion inside the aperture to permit gear 180 to rotate with respect to casing 152. Gear 180 also includes an internal cavity 188 that is configured to engage forward end 148 of motor shaft 146. Cavity 188 is preferable configured to have flats, splines or a similar surface to permit the motor to rotate the gear, yet to also permit end 148 of shaft 146 to be slidingly inserted into and removed from gear 180.

Bevel gears 180 and 182 preferably rotate about axes disposed at a right angle to one another. Bevel gear 182 is supported for rotation on gear shaft 170. Both gear shaft 170 and motor shaft 146, which are coaxial with their associated bevel gears 182 and 180 mounted thereon, also lie in a horizontal plane and rotate about axes at right angles to one another—the same axes about which gears 180 and 182 rotate.

Gear shaft 170 is supported within axle housing 136 by two bearings 164 and 190 that are coupled to opposing ends of shaft 170. Bearing 190 is mounted to casing 152 itself, and bearing 164 is mounted to cover 165.

A second gear, spur pinion gear 192, is also mounted on shaft 170 for rotation. Gear 192 is fixed with respect to gear 182 to rotate with gear 182 at the same speed.

The second speed-reducing gear set 176 includes gear 192 and spur gear 194, which are mounted on parallel and horizontal shafts 170 and 168, respectively. These gears are in continuous meshing engagement. The gear set is a speed-reducing gear set because gear 192 has fewer teeth than gear 194.

Gear shaft 168, on which gear 194 is mounted, is supported at its opposing ends within axle housing 136 by bearings 162 and 196. Bearing 162 is mounted in cover 165, and bearing 196 is mounted in casing 152.

A second gear, spur pinion gear 198 is also mounted on shaft 168 for rotation. Gear 194 is fixed with respect to gear 198 to rotate together with gear 198 at the same speed.

The third speed-reducing gear set 178 includes gear 198 mounted on shaft 168 and spur gear 200 mounted on axle 166. Shaft 168 and axle 166 are both parallel to one another and horizontal. Gears 198 and 200 are in continuous meshing engagement. The gear set is a speed-reducing gear set because there are fewer teeth on gear 198 than on gear 200.

Axle 166, on which gear 200 is mounted, is supported at its opposing ends within axle housing 136 by bearings 160 and 202. Bearing 160 is mounted in cover 165, and bearing 202 is mounted in casing 152.

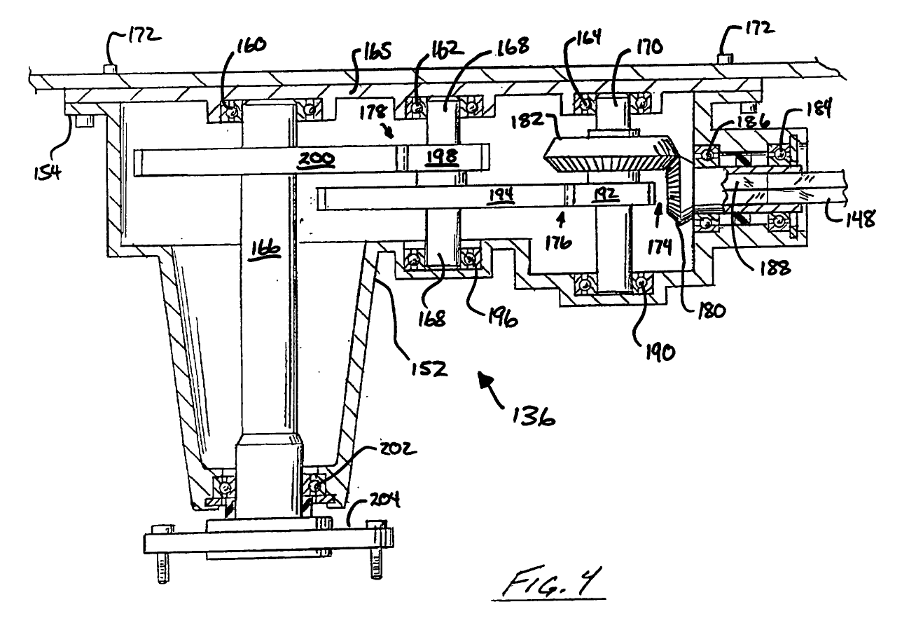

Gear 200 is fixed to rotate with and drive a wheel-mounting surface (shown in FIG. 4 as a flange 204) that extends radially outward from the outer end of axle 166. This flange is disposed outside of axle housing 136, thus axle 166 serves to communicate the torque applied to gear 200 inside housing 136 to wheel 106 outside housing 136.

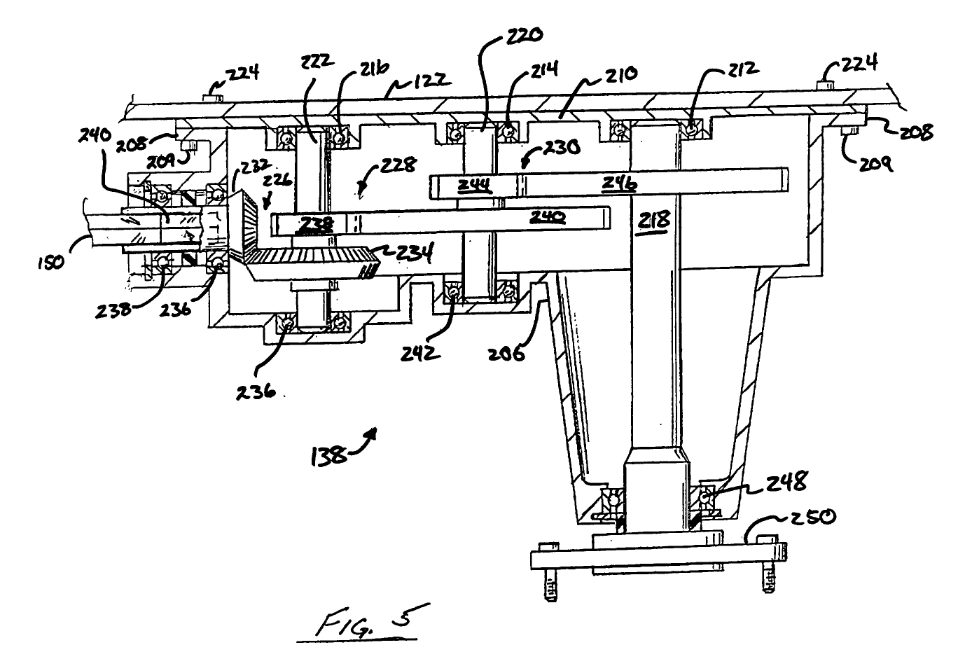

Referring to FIGS. 3 and 5, rear axle housing 138 includes an elongated generally conical casing 206 that has a smaller conical diameter the farther one moves away from the vehicle toward wheel 110. This casing 206 includes a flange 208 at its inboard edge through which a plurality of bolts 209 are inserted to fix the flange (and hence casing 206) to left sidewall 122 of the vehicle.

Casing 206, like the three other casings of the vehicle, supports the weight of the vehicle as it travels over the ground. The weight of the vehicle is transmitted from the chassis to the flanges, and thence through axle bearings located in the casing to the axle. The weight on the axle is thence transmitted to the ground.

Axle housing 138 includes a cover 210 that is bolted to and encloses casing 206. Three bearings 212, 214, and 216 are fixed to and supported by cover 210. These bearings respectively support axle 218, gear shaft 220, and gear shaft 222 at their inner ends for rotation with respect to axle housing 138. Bolts 224 extend through holes in cover 210 into casing 206 to which they are threadedly engaged to fix cover 210 thereto.

Axle housing 138 has three speed-reducing gear sets 226, 228, and 230 that are connected in series to reduce the speed of motor 114 and increase the torque applied to wheel 110.

Gear set 226 includes two bevel gears, a bevel pinion gear 232, and a bevel gear 234 disposed at right angles to gear 232. The two gears are in continuous meshing engagement, with gear 232 driving gear 234.

Bevel pinion gear 232 includes an elongated cylindrical portion that is supported within an aperture in casing 206. Bearings 236 and 238 are mounted on the cylindrical portion inside the aperture to permit gear 232 to rotate with respect to casing 206. Gear 232 also includes an internal cavity 240 that is configured to engage rearward end 150 of motor shaft 146. Cavity 240 is preferable configured to have flats, splines or a similar surface to permit the motor to rotate the gear, yet to also permit end 150 of shaft 146 to be slidingly inserted into and removed from gear 232.

Bevel gears 232 and 234 preferably rotate about axes disposed at a right angle to one another. Bevel gear 234 is supported for rotation on gear shaft 222. Both gear shaft 222 and motor shaft 146, which are coaxial with their associated bevel gears 234 and 232 mounted thereon, also lie in a horizontal plane and rotate about axes at right angles to one another—the same axes about which gears 232 and 234 rotate.

Gear shaft 222 is supported within axle housing 138 by two bearings 216 and 236 that are coupled to opposing ends of shaft 222. Bearing 236 is mounted to casing 206 itself, and bearing 216 is mounted to cover 210.

A second gear, spur pinion gear 238, is also mounted on shaft 222 for rotation. Gear 238 is fixed with respect to gear 234 to rotate with gear 234 at the same speed.

The second speed-reducing gear set 228 includes gear 238 and spur gear 240, which are mounted on parallel and horizontal shafts 222 and 220, respectively. These gears are in continuous meshing engagement. The gear set is a speed-reducing gear set because gear 238 has fewer teeth than gear 240.

Gear shaft 220, on which gear 240 is mounted, is supported at its opposing ends within axle housing 138 by bearings 214 and 242. Bearing 214 is mounted in cover 210, and bearing 242 is mounted in casing 206.

A second gear, spur pinion gear 244, is also mounted on shaft 220 for rotation. Gear 240 is fixed with respect to gear 244 to rotate together with gear 244 at the same speed.

The third speed-reducing gear set 230 includes gear 244 mounted on shaft 220 and spur gear 246 mounted on axle 218. Shaft 220 and axle 218 are both parallel to one another and horizontal. These gears are in continuous meshing engagement. The gear set is a speed-reducing gear set because there are fewer teeth on gear 244 than on gear 246.

Axle 218, on which gear 246 is mounted, is supported at its opposing ends within axle housing 138 by bearings 212 and 248. Bearing 212 is mounted in cover 210, and bearing 248 is mounted in casing 206.

Gear 246 is fixed to rotate with a wheel-mounting surface, shown in FIG. 4 as a flange 250 that extends radially outward from the end of axle 218. This flange is disposed outside of axle housing 138, thus axle 218 serves to communicate the torque applied to gear 246 from inside housing 138 to outside housing 138, and to wheel 110.

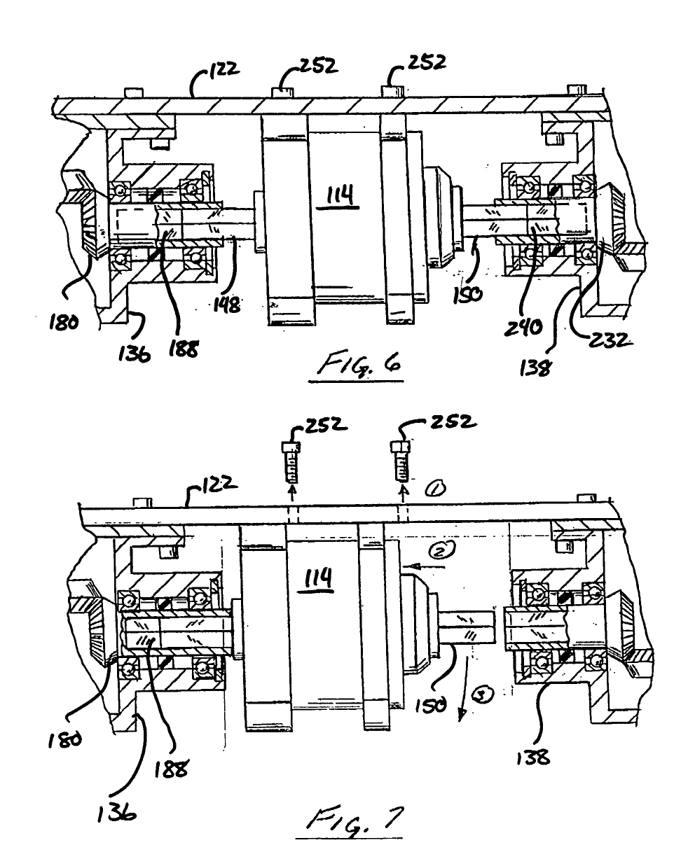

FIG. 6 shows hydraulic motor 114 as it is coupled to front and rear axle housings 136 and 138. Shaft 146 of motor 114 extends from both ends of the motor and engages the bevel pinion gears of both the axle housings. Whenever motor 114 rotates, it rotates both pinion gears at the same speed and in the same direction.

Motor 114 is fixed to sidewall 122 of the vehicle by bolts 252, which extend through apertures in the sidewall and are threadedly engaged with apertures in motor 114. Ends 148 and 150 of motor shaft 150 are disposed in apertures or cavities 188 and 240 to transmit the rotational power generated by motor 114 to the bevel gears. These ends are preferably slidably engaged to the bevel gears such that the ends can be removed by sliding the motor back-and-forth.

FIG. 7 shows the process for removing the hydraulic motor. This process can be performed without removing the axle housings from the sidewalls of the vehicle. In the first step, bolts 252 are removed from the motor and sidewall 122. This permits the motor to move freely back-and-forth. Once the bolts are removed, the motor is moved axially to the left as shown in FIG. 7, inserting end 148 of the motor shaft deeper into aperture or cavity 188 of bevel gear 180 until motor shaft end 150 pulls free from the aperture or cavity of bevel gear 232. In this position, the motor can be pivoted about end 148 until end 150 clears housing 138. In this tilted position, the motor can be pulled out of the aperture or cavity of bevel gear 180 and completely removed from both housings. For ease of illustration, the hydraulic lines that connect motor 114 to its pump (see FIG. 9) have been removed from FIGS. 6 and 7.

This completes the description of drive system 134 located at the left side of the vehicle. As best shown in FIG. 2, an identical drive system is disposed on the right side of the vehicle that is a mirror image of the drive system on the left side of the vehicle mirrored about a longitudinal axis or plane extending the length of the vehicle. It is the same in all respects as the drive system on the left side of the vehicle, and therefore is not separately described herein. The benefits of its construction are the same. The alternative structures are the same, and the preferred features and capabilities of it are the same as well.

Drive system 140 is preferably fixed to the right sidewall of the vehicle such that the front axles of the left and right side drive systems of the vehicle are coaxial. The rear axles of the left and right side drive systems are also preferably coaxial.

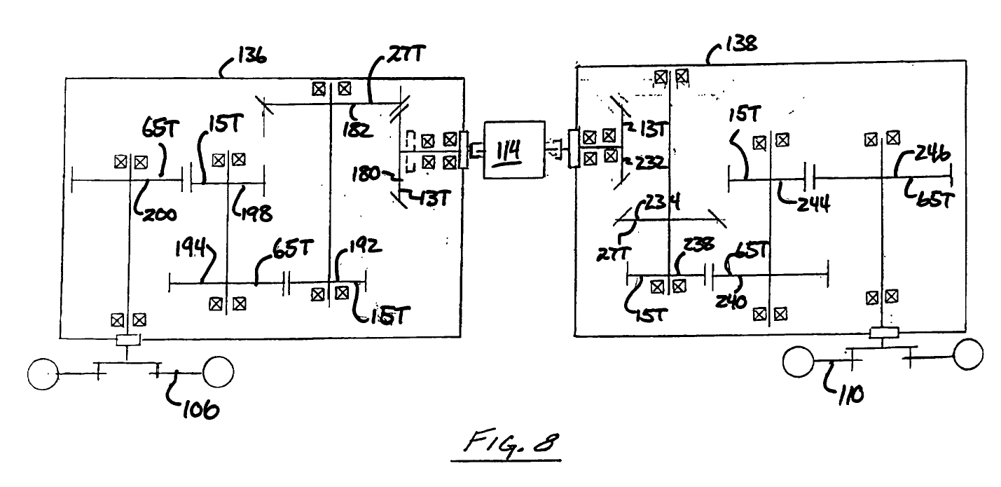

FIG. 8 is a diagram of the reduction gear ratios provided by the drive systems and is illustrated in schematic form.

The first speed-reducing gear set of housings 136 and 138 provide a gear reduction ratio of 27:13. Bevel pinion gears 180 and 232 have 13 teeth and the bevel gears 182 and 234 with which they are in meshing engagement with have 27 teeth. The preferred gear reduction ratio of these gear sets ranges between 1.5:1 and 2.75:1. It is preferable that the reduction ratio and the number of teeth of the gears in both front and rear housing gear sets is the same.

The second speed-reducing gear set of housings 136 and 138 provide a gear reduction ratio of 65:15. Spur pinion gears 192 and 238 have 15 teeth and spur gears 194 and 240 with which they are in meshing engagement have 65 teeth. The preferred gear reduction ratio of these gear sets range between 3:1 and 5.5:1. It is preferable that the reduction ratios and the number of teeth of the gears in both front and rear housing gear sets is the same.

The third speed-reducing gear set of housings 136 and 138 provide a gear reduction ratio of 65:15. Spur pinion gears 198 and 244 have 15 teeth and spur gears 200 and 246 with which they are in meshing engagement have 65 teeth. The preferred gear reduction ratio of these gear sets range between 3:1 and 5.5:1. It is preferable that the reduction ratios and the number of teeth of the gears in both front and rear housing gear sets is the same.

The overall gear reduction ratio of both axle housings is 39:1. The preferred overall gear reduction ratio for both housings is between 28:1 and 50:1. The reduction ratio for both front and rear axle housings is preferably the same.

While the discussion above relates to the drive system for the left side of the vehicle, the same number of gear teeth, gear ratios and desirable gear ratios would be the same for the drive system on the opposing side of the vehicle as well.

FIG. 9 illustrates the hydraulic circuit for driving the skid steer vehicle. It includes engine 102 that is coupled to and drives hydraulic pumps 118 and 120, which, in turn, are hydraulically coupled to and drive hydraulic motors 114 and 116, respectively.

Pumps 118 and 120 are variable displacement hydraulic pumps, which are hydraulically coupled to two respective hand controls 254 and 256 for controlling the displacement of the pumps. Hand controls 254 and 256 are respectively mechanically coupled to and control the position of hydraulic valves 258 and 260. Hydraulic valves 248 and 260, are, in turn, hydraulically coupled to pumps 118 and 120 to vary the displacement of these pumps. The displacement of the pumps can be not only varied in magnitude, but in direction, as well. By manipulating each of the hand controls away from a neutral position in a first direction, hydraulic fluid can be made to flow in a first direction through the associated pump. By manipulating each of the hand controls away from a central neutral position in a second, and opposing direction, hydraulic fluid can be made to flow in a second opposite direction through the associated pump.

Pumps 118 and 120 are in fluid communication with motors 114 and 116, respectively. More particularly, pump 118 is in a series hydraulic circuit with motor 114 and pump 120 is in a series hydraulic circuit with motor 116. These two circuits are independent. Substantially all the hydraulic fluid provided by pump 118 is directed to and through motor 114 and substantially all the hydraulic fluid provided by pump 120 is directed to and through motor 116.

Motors 114 and 116 are bidirectional. In other words, they will turn in both directions depending upon the direction of fluid flow through the motors. Thus, when the hand controls are manipulated, they can drive the wheels on each side of the vehicles independently of the wheels on the other side of the vehicle. They can drive the wheels on both sides of the vehicle forward (and at different or the same speed). They can drive the wheels on opposing sides of the vehicle backwards (and at the same or different speeds). They can drive the wheels on opposing sides of the vehicle in opposite directions and at the same or different speeds. By “opposite directions” we mean that the wheels on one side of the vehicle can be driven in a direction to move that side of the vehicle forward and the wheels on the opposing side of the vehicle can be driven in a rotational direction that will move that side of the vehicle backward.

A third pump is provided in FIG. 8, called charge pump 119. Charge pump 119 is in fluid communication with hydraulic motors 114 and 116, and hydraulic pumps 118 and 120 to provide “make-up” hydraulic fluid for the hydraulic circuits extending between with hydraulic motors 114 and 116, and hydraulic pumps 118 and 120. These circuits may leak, and they may lose fluid when overpressurized. As a result, some means to supply them with additional hydraulic fluid is required. Hydraulic pump 119 provides that capability. Charge pump 119 sucks fluid from tank 262 and supplies it under pressure to accumulator 264. Accumulator 264, in turn, is in fluid communication with the series drive circuits and supplies them with hydraulic fluid to make up their losses.

The two series hydraulic circuits that extend between pump 118 and motor 114 and between pump 120 and motor 116 are provided with pressure relief and anti-cavitation valves.

The series circuit including pump 118 and motor 114 also includes back to-back pressure relief valves 266 and 268 that are in fluid communication with the two respective conduits extending from pump 118 to motor 114. These valves 266 and 268 are also coupled to tank 262. When the pressure in either conduit exceeds the operating pressure, the pressure relief valve opens and conducts fluid back to tank 262. Pressure relief valves 270 and 272 are similarly coupled to the two conduits extending between pump 120 and motor 116 to provide the same function.

The series circuit including pump 118 and motor 114 also includes back-to-back anti-cavitation valves 274 and 278, each coupled in parallel with pressure relief valves 266 and 268. These valves are essentially check valves that permit fluid from tank 262 to be sucked into the conduits extending between pump 118 and motor 114 whenever the pressure in those conduits approaches zero psi. By permitting hydraulic fluid to be sucked back into these conduits, the pressure in the conduits is maintained above that at which the hydraulic fluid would flash into vapor—i.e. cavitation pressure. Another pair of anti-cavitation valves 280 and 282 is similarly coupled to and between the hydraulic lines that extend between pumps 120 and motor 116, and tank 262 to provide the same anti-cavitation function for the hydraulic circuit that controls the motors on the right-hand side of the vehicle.

While the embodiments illustrated in the FIGURES and described above are presently preferred, it should be understood that these embodiments are offered by way of example only. The invention is not intended to be limited to any particular embodiment, but is intended to extend to various modifications that nevertheless fall within the scope of the appended claims.

For example, the particular types of gear sets, whether spur or bevel can be replaced with gears sets of another type. Additionally, the motor shaft can have female ends rather than the described male ends and the corresponding bevel gears that it engages in the front and rear axle housings can have male members rather that hollow female members to engage the ends of the drive shaft or drive shafts. Alternatively, couplings can be disposed between the bevel gears and the motors. The axles and spur gears thereon can be forged in a single net forging process as a single unitary and integral structure. The axle housings are shown as a single housing with a cover fixed against the sidewalls of the vehicle to provide a complete enclosure for the reduction gears inside the axle housings. The shafts on which the bevel gears are mounted and the bevel gears themselves may be net forged. In an alternative embodiment, the cover can be eliminated and the casings fixed directly to the sidewalls of the vehicle. In this alternative embodiment, the shafts and axles inside the casings could either be supported by bearings that are mounted to the casing alone or the shafts and axles could be supported by bearings mounted to the sidewall (rather than the bearings being supported by the cover as shown in the illustrated embodiment).

What is claimed is:

1. A skid steer vehicle, comprising:
a chassis having first and second sidewalls;
an engine mounted to the chassis and having at least first and second hydraulic pumps; and
first and second drive systems, disposed adjacent to the first and second sidewalls, respectively, each drive system including:
a hydraulic motor having an output shaft with first and second ends and an axis of rotation;
a first axle housing coupled to the first end of the output shaft that includes at least first, second and third reduction gear sets and a first axle that extends laterally outward away from the first axle housing;
a second axle housing coupled to the second end of the driveshaft that includes at least fourth, fifth and sixth reduction gear sets and a second axle that extends laterally outward away from the second axle housing; and
two wheels, each wheel being driven by one of the first and second axles;
wherein the hydraulic motor of the first drive system is fluidly coupled to the first hydraulic pump to be driven thereby and further wherein the hydraulic motor of the second drive system is fluidly coupled to the second hydraulic pump to be driven thereby.

2. The vehicle of claim 1, wherein at least one of the first, second and third gear sets is a bevel gear set and wherein at least one of the fourth, fifth and sixth gear sets is a bevel gear set.

3. The vehicle of claim 2, wherein the output shaft of the hydraulic motor extends fore-and-aft.

4. The vehicle of claim 3, wherein the first and second axles are parallel to one another and extend laterally away from the vehicle and further wherein the first axle is parallel to at least two internal gear shafts in the first axle housing and the second axle is parallel to at least two internal gear shafts in the second axle housing.

5. The vehicle of claim 4, wherein the first axle housing includes at least one bevel gear that is engaged to the output shaft of the hydraulic motor to rotate coaxially therewith and at the same rotational speed and further wherein the second axle housing includes at least one bevel gear that is engaged to the output shaft of the hydraulic motor to rotate coaxially therewith and at the same rotational speed.

6. The vehicle of claim 1, wherein the gear reduction ratios of the first, second and third gear sets are the same as the gear reduction ratios of the fourth, fifth and sixth gear sets, respectively.

7. The vehicle of claim 1, wherein the first and second axle housings of the first drive system are fixed to the outer surface of the first sidewall, and wherein the first and second axle housings of the second drive system are fixed to the outer surface of the second sidewall.

8. The vehicle of claim 7, wherein the hydraulic motor of the first drive system is disposed between the first and second axle housings of the first drive system and wherein the hydraulic motor of the second drive system is fixed between the first and second axle housings of the second drive system.

10. A drive system for a skid steer vehicle, comprising:
a hydraulic motor having an output shaft with an axis of rotation;
a first axle housing coupled to the first end of the driveshaft that includes at least first, second and third reduction gear sets and a first axle that extends laterally outward away from the first axle housing;
a second axle housing coupled to the second end of the driveshaft that includes at least fourth, fifth and sixth reduction gear sets and a second axle that extends laterally outward away from the second axle housing; and
two wheels, each wheel being driven by one of the first and second axles.

11. The vehicle of claim 10, wherein at least one of the first, second and third gear sets is a bevel gear set and wherein at least one of the fourth, fifth and sixth gear sets is a bevel gear set.

12. The vehicle of claim 11, wherein the output shaft of the hydraulic motor extends fore-and-aft.

13. The vehicle of claim 12, wherein the first and second axles are parallel to one another and extend laterally away from the vehicle and further wherein the first axle is parallel to at least two internal gear shafts in the first axle housing and the second axle is parallel to at least two internal gear shafts in the second axle housing.

14. The drive system of claim 13, wherein the first axle housing includes a first internal shaft that is disposed parallel to the first axle and further wherein the second reduction gear set is the speed-reducing spur gear set and includes a first spur gear mounted on the first axle and a second spur gear mounted on the first internal shaft.

15. The drive system of claim 14, wherein the first axle housing includes at least one bevel gear that is engaged to the output shaft of the hydraulic motor to rotate coaxially therewith and at the same rotational speed and further wherein the second axle housing includes at least one bevel gear that is engaged to the output shaft of the hydraulic motor to rotate coaxially therewith and at the same rotational speed.

16. The drive system of claim 10, wherein the gear reduction ratios of the first, second and third gear sets are the same as the gear reduction ratios of the fourth, fifth and sixth gear sets, respectively.

17. The drive system of claim 10, wherein the first and second axle housings of the first drive system are configured to be fixed to the outer surface of a first sidewall of the vehicle, and wherein the first and second axle housings of the second drive system are configured to be fixed to the outer surface of a second sidewall of the vehicle.

18. The drive system of claim 17, wherein the hydraulic motor of the first drive system is disposed between the first and second axle housings of the first drive system and wherein the hydraulic motor of the second drive system is fixed between the first and second axle housings of the second drive system.

19. The drive system of claim 17, wherein the driveshaft drivingly engages both the second and fourth bevel gears.
